(19) United States
(12) Patent Application Publication
(10) Pub. No.: US 2026/0177013 A1
(43) Pub. Date: Jun. 25, 2026

(54) METHOD FOR REDUCING THE POLLUTING EMISSIONS OF A HYBRID DRIVE DEVICE

(71) Applicant: HORSE POWERTRAIN SOLUTIONS, S.L.U., Alcobendas, Madrid (ES)

(72) Inventor: Bertrand FASOLO, Lardy (FR)

(21) Appl. No.: 19/122,868

(22) PCT Filed: Oct. 19, 2023
(86) PCT No.: PCT/EP2023/079106

§ 371 Date: Apr. 21, 2025

(30) Foreign Application Priority Data
Oct. 19, 2022 (FR) FR2210823

(51) Int. Cl. F02D 41/02; B60K 6/48; B60W 10/06

(52) U.S. Cl. CPC F02D 41/0295; B60K 6/48; B60W 10/06; B60L 2240/486

(57) ABSTRACT

A method is for reducing the polluting emissions of a spark-ignition internal combustion engine associated with at least one electric machine capable of operating at least in a generator mode, capable of driving at least one driving wheel of a motor vehicle via a system for transmitting a driving torque of the vehicle. The method includes: a stage of changing a gear ratio of a gearbox of the transmission system to a higher gear ratio, the stage of changing gear ratio having a prior detection stage and an engagement stage; a stage of engine adjustment comprising a fuel injection stage and a fuel ignition stage with an optimal ignition advance; a stage of controlling the electric machine operating according to a generator mode which generates a resistant torque throughout the duration of the gear change.

### TECHNICAL FIELD

The present invention relates generally to the reduction of polluting emissions from internal combustion engines.

It finds an advantageous application in a motor vehicle equipped with a spark-ignition engine associated with at least one electric machine.

### PRIOR ARTS

A motor vehicle equipped with a combustion engine is generally equipped with a system for post-treatment of the polluting species of the vehicle's exhaust gases in order to reduce the emissions of these polluting species.

The aftertreatment system of a spark-ignition engine (of the type operating in particular on gasoline) generally comprises a three-way catalyst which performs catalytic treatment of the exhaust gases, such as, for example, oxidations of carbon monoxide and unburnt hydrocarbons, and reductions of nitrogen oxides. The treatment efficiency of the different polluting species depends on the amount of oxygen stored in the catalyst.

When the amount of oxygen stored in the catalyst is close to zero, the oxidation efficiency of some polluting species decreases. This is particularly the case for unburnt hydrocarbons and carbon monoxide.

When the amount of stored oxygen is close to the maximum oxygen storage capacity of the catalyst, the reduction efficiency of polluting species, for example for nitrogen oxides, decreases.

The amount of oxygen stored in the catalyst depends on the injection of an air-fuel mixture.

During certain driving situations, for example during a gear shift of a gearbox or a phase called lifting of the foot during which the driver completely lifts the foot off the accelerator pedal, the fuel injection is automatically cut off to decrease the fuel consumption and air is sent into the after-treatment system. The amount of oxygen stored in the catalyst then increases, for example up to the maximum storage capacity value of the catalyst, and polluting species are no longer treated effectively, more particularly nitrogen oxides (NOx) essentially comprising nitrogen monoxide and nitrogen dioxide.

When resuming fuel injection, while the amount of oxygen stored in the catalyst has reached the OSC meaning that the catalyst is saturated with oxygen, a strategy of purging or lowering the oxygen load of the catalyst is usually carried out. The catalyst purge strategy comprises increasing the richness of the injected air-fuel mixture to a richness greater than 1, i.e. increasing the proportion of fuel in the injected air-fuel mixture such that the proportion of fuel is greater than that present in the stoichiometric air-fuel mixture, so as to rapidly decrease the amount of oxygen stored in the catalyst. However, the catalyst purge strategy significantly increases the vehicle's fuel consumption and NOx emissions. Indeed, during the period during which the catalyst is saturated with oxygen, the NOx treatment efficiency of the catalyst is very low, or even zero.

It is known that the richness of the injected air-fuel mixture influences the amount of oxygen stored in the catalyst. Thus, a solution to limit the increase in the amount of oxygen stored in the catalyst, for example when changing gear ratios, is to maintain the richness of the injected air-fuel mixture in stoichiometric proportions by delaying the fuel injection cut previously mentioned so as not to saturate the catalyst with oxygen. The delay before cutting off the fuel injection is generally set to a predetermined and constant duration as described in unpublished patent application FR 21 01 953.

An improvement proposed in unpublished patent application FR 22 02 809 sets the delay before the fuel injection is cut to a duration dependent on the maximum current oxygen storage capacity of the catalyst.

Nevertheless, these strategies of delaying the cut-off of the injection do not take into account the possible dispersion of the shift times of the gearbox ratios. For example, a slow passage leads to maximizing the oxygen loading of the catalyst.

The solution described in unpublished patent application FR 22 07 721 first proposes cutting off the fuel injection and then anticipating the resumption of fuel injection when the catalyst approaches oxygen saturation.

However, these methods of cutting the injection remain approximate as to when the injection is stopped or resumed, since the oxygen content of the catalyst is not precisely known. This inaccuracy generates in particular a risk of NOx pollution, as well as a risk of parasitic residual engine torque.

### EXPLANATION OF THE INVENTION

In view of the above, the invention aims to strengthen the robustness of the treatment of polluting emissions, in particular NOx.

The invention relates to a method for reducing polluting emissions from a spark-ignition internal combustion engine associated with at least one electric machine capable of operating in at least one generator mode, capable of driving at least one driving wheel of a motor vehicle via a system for transmitting a driving torque of the vehicle.

The method comprises:
a stage of changing a gear of a gearbox of said transmission system to a higher gear, said gear change stage comprising a prior stage of detecting a command to change said gear by the higher gear and a stage of engaging said higher gear corresponding to the end of the gear change;
a stage of engine adjustment performed after detection of said change command and comprising a fuel injection stage and a fuel ignition stage with a predetermined ignition advance that maximizes a thermal torque produced by the engine;
a stage of controlling said electrical machine carried out concomitantly with the stage of adjusting the motor, said electrical machine operating according to a generator mode which generates a resistant torque (C_el) throughout the duration of the gear change.

According to one characteristic, the injected fuel amount corresponds to a target value of unit richness.

According to another characteristic, the injected fuel amount corresponds to a predetermined target value of oxygen stored in a three-way catalyst mounted at the exhaust of the engine.

According to another feature, the stage of adjusting the engine comprises a stage of reducing the amount of air admitted into the engine to a minimum amount of air corresponding to a predetermined minimum pressure in an intake manifold of the engine.

Advantageously, the resistive torque is representative of the work done by the electric machine to charge a battery.

Preferably, the total effective torque equal by definition to the sum of the thermal torque produced by the motor and the resistant torque generated by the electric machine is slightly negative.

For example, the value of the total effective torque makes it possible to lower the engine speed to a target speed value (N_{target}) calculated according to the speed of the vehicle (V_{vehicle}) and a gear ratio of the gearbox (V₁₀₀₀), according to the following equation:

$${N}_{target} = \frac{{V}_{vehicle}}{{V}_{1000}} , \qquad ( Eq . 1 )$$

wherein the gear ratio (V₁₀₀₀) is expressed in km/h per 1000 rpm.

Preferably, the stage of engaging the upper gear is performed when the engine speed reaches the target speed value (N_{target}).

According to another aspect, the invention also relates to a motorization device of a motor vehicle comprising an electronic control unit, a spark-ignition internal combustion engine and at least one electric machine capable of operating at least in a generator mode, said motorization device being associated with a manual gearbox of a transmission system of said vehicle and implementing a method as described above.

### BRIEF DESCRIPTION OF THE DRAWINGS

Other aims, characteristics and advantages of the invention will become apparent on reading the following description, given solely by way of non-limiting example, and made with reference to the appended drawings in which:

FIG. 1 is a schematic view illustrating a motorization device according to the invention;

FIG. 2 is a flowchart illustrating the different stages of a method for reducing polluting emissions according to an embodiment of the invention;

FIG. 3 illustrates the evolution of different parameters of the motorization device during the stages of the method according to the invention.

### DETAILED DESCRIPTION OF AT LEAST ONE EMBODIMENT

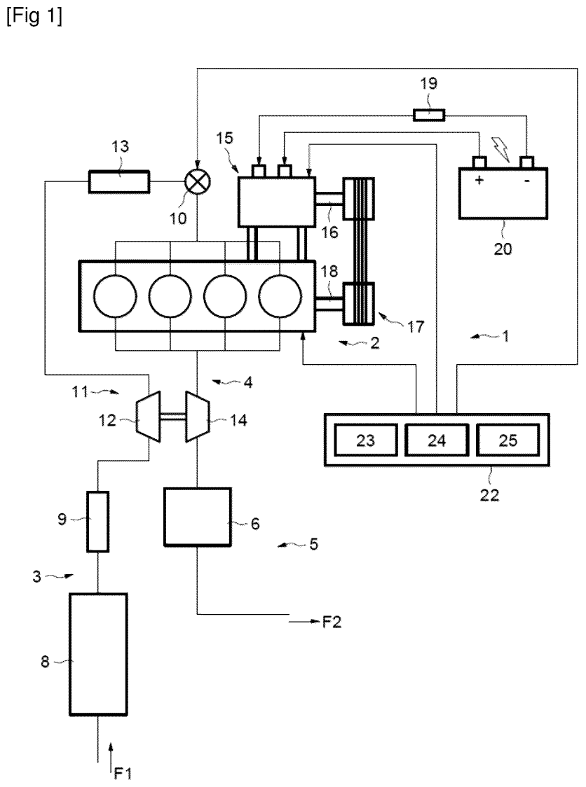

FIG. 1 schematically illustrates a motorization device 1 according to the invention that can be fitted to a vehicle, in particular a motor vehicle. It comprises a heat engine 2, with internal combustion and controlled ignition, which is here in a non-limiting manner in the form of a supercharged in-line four-cylinder engine. Of course, the motor can also be of the natural suction type without departing from the scope of the invention.

For its operation, such a heat engine 2 sucks air in the direction of arrow F1 through an intake pipe 3, and discharges its exhaust gases through an exhaust pipe 4 in order to direct them to a depollution device 5. The pollution control device 5 comprises a catalyst 6 of the three-way type.

At the outlet of the depollution device 12, the exhaust gases are discharged into the outside atmosphere in the direction of arrow F2.

The engine 2 also consumes fuel, for example gasoline, a mixture of gasoline and ethanol, or even pure ethanol, which is supplied to the engine by means of an injection system (not shown), for example a direct injection system which comprises a feed rail common to the cylinders and at least one fuel injector per cylinder capable of injecting the fuel directly into each of the cylinders.

In the air intake pipe 3, there may be an air filter 8 which makes it possible to remove the dust contained in the air, a flowmeter 9 which makes it possible to determine the mass flow rate of fresh air admitted into the engine 2, and an air intake flap 10, or throttle box 10 which makes it possible to regulate the flow rate admitted into the engine 2 by more or less obstructing the intake pipe 3.

In the case of a supercharged engine 2, the heat engine 2 also comprises a turbocharger 11, the compressor 12 of which is interposed in the intake pipe 3 between the air filter 8 and the throttle housing 10. In addition, it is possible for a temperature exchanger 13 to be arranged in the intake pipe 3, between the compressor 12 and the throttle housing 10, so as to cool the air compressed by the compressor 12.

The compressor 12 is driven by the turbine 14 of the turbocharger 11, which is interposed in the exhaust pipe 4 between the engine 2 and the depollution device 5. In addition, the heat engine 2 may comprise one or more intake exhaust gas recirculation circuits (not shown), more particularly a so-called high-pressure EGR circuit and/or a low-pressure EGR circuit, EGR being the acronym for “Exhaust Gas Recycling”. The heat engine 2 may also have a variable valve timing (VVT) distribution.

In a manner known per se, the heat engine 2 produces an engine torque, called thermal torque C_comb, which results from the combustion of a mixture of fresh air and fuel in quantities well defined by a computer of the engine 2. Recycled exhaust gases recycled to the intake can also be added to the fresh air.

The motorization device 1 according to the invention also comprises an electric machine 15 able to operate at least according to a generator mode. In generator mode, the electric machine 15 is an alternator that provides an electric current intended to be stored in a battery of accumulators not shown. In motor mode, on the contrary, it is powered by current previously stored in the accumulator battery and provides a motor torque that can be transmitted to the wheels of the vehicle, in addition to or in replacement of the torque provided by the heat engine 2.

The electric machine 15, for example an alternator-starter 15 separate from the flywheel of the heat engine 2, and a rotary shaft 16 of which is coupled via transmission means 17 to a rotary shaft 18 of the heat engine 2, for example a crankshaft, is capable of operating in engine mode or in generator mode under the supervision of a control box 19.

In generator mode, the electric machine 15 is an alternator that supplies an electric current intended to be stored in a battery 20 of accumulators by taking a resistive electric torque C_el.

In motor mode, the electric machine 15 is instead powered by current previously stored in the battery 20 and it provides an electric torque that is added to that C_comb of the heat engine 2 to be transmitted to the wheels of the vehicle.

The motorization device 1 is associated with a transmission system (not shown) comprising in particular a manual gearbox, a differential axle and a transmission shaft making it possible to transmit to the wheels of the vehicle the torque provided by the motorization device 1. A manual gearbox is a gearbox wherein the shift is carried out at the initiative of the driver.

In addition, the engine is equipped with a control system 1 comprising an electronic control unit 22 configured to control the various elements of the internal combustion engine 2 on the basis of data collected by sensors at different locations on the engine.

The electronic control unit 22 comprises a calculation module 23, a measurement module 24 and a control module 25.

The control module 25 is for example able to control the electric torque of the electric machine 15, the fuel injection system of the engine 2 and the opening and closing of the butterfly housing 10.

The mode of operation of the motorization device 1 is as follows: the depression of the accelerator pedal (not shown) of the vehicle by the driver is translated by an electronic control unit 21 into a torque setpoint C to be transmitted to the wheels of the vehicle. The torque C can then be obtained either in the form of thermal torque, or in the form of electrical torque, or in the form of a combination of the two. In all cases, the value of the torque C is equal to the algebraic sum of the values of the thermal torque C_comb and the electric torque C_el, the latter taking a positive value in motor mode and a negative value in generator mode of the electric machine 15, the electronic control unit 21 performing the distribution according to different parameters of the vehicle and/or the motorization device 1.

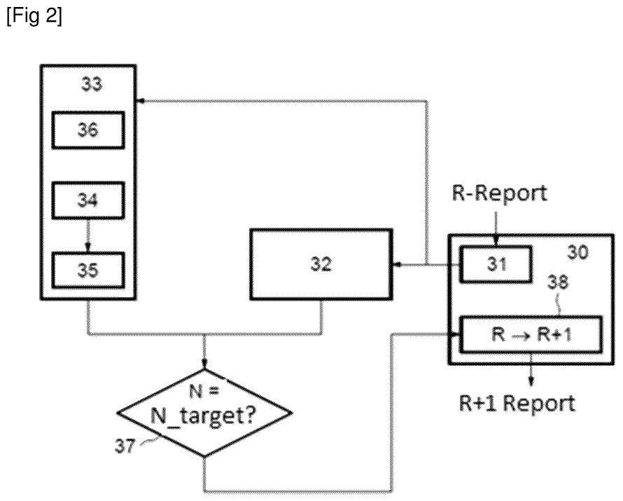

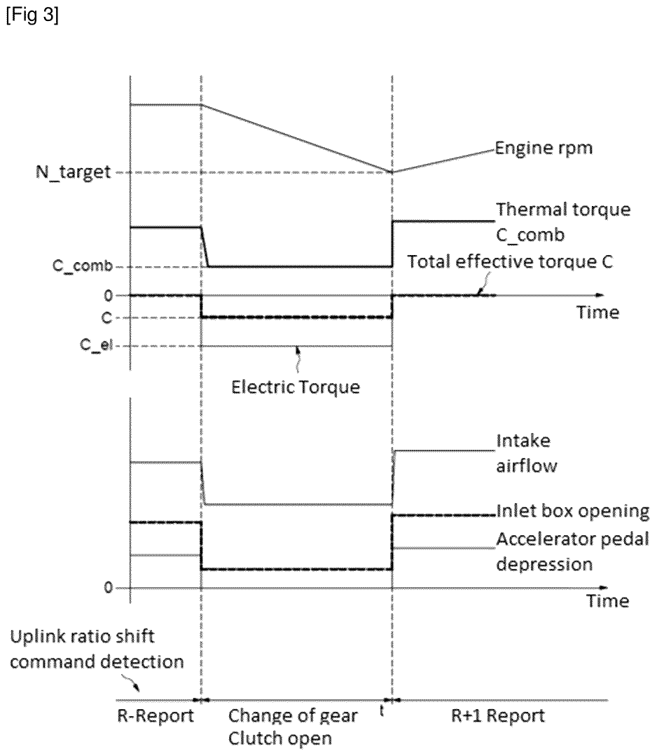

A method for reducing polluting emissions according to the invention will now be described with reference to FIGS. 2 and 3.

FIG. 2 illustrates the different stages of a method for reducing polluting emissions according to an embodiment of the invention, using a motorization device 1 as described previously.

The reduction method begins with a stage 30 of changing a gear ratio of a gearbox of the vehicle transmission system to a higher gear ratio, that is, an upshift. Stage 30 comprises a prior stage 31 of detecting a command to change said ratio to a higher ratio and a stage 38 of engaging the higher ratio corresponding to the end of the ratio change. The gear change control is generally materialized by the actuation of the clutch pedal that the electronic control unit is able to detect. It should be noted that in the case of manual gearboxes, the clutch remains open for the entire duration of the gear change. In a known manner, the electronic control unit 22 is able to detect that it is an acceleration phase from several parameters such as the derivative of the speed and the depression of the accelerator pedal.

When the upshift command is detected, the method continues with a stage 32 of controlling the electric machine and a stage 33 of adjusting the concomitant motor.

In the stage 32 of controlling the electric machine 15, the electronic control unit 22 adjusts the operation of the electric machine 15 according to a generator mode that generates a resistant torque C_el throughout the duration of the gear change.

The stage 33 of adjusting the engine 2 comprises a stage 34 of injecting fuel followed by a stage of igniting the injected fuel with a predetermined ignition advance that maximizes the thermal torque C_comb produced by the engine from the mass of air admitted therein.

The fuel injection is maintained during the gear change in the same way as the conventional mode of nominal operation of the engine used outside the gear change phases.

Preferably, the richness regulation continuously adjusts the injected fuel amount to achieve, regardless of the mass of air admitted into the engine 2, a mixture of air and fuel according to stoichiometric proportions, that is to say at unit richness. The richness regulation is conventionally done in a closed loop on a unit set value by adjusting the fuel injection from the indications of an oxygen sensor mounted upstream of the catalyst. Alternatively, it is possible to provide that the injected fuel amount corresponds to a predetermined target value of oxygen stored in a three-way catalyst mounted at the engine exhaust, as described for example in document FR-A1-30 33 364.

The ignition advance is not degraded and remains constantly at optimal values. Thus, the engine 2 provides the maximum possible torque for the admitted air mass.

Preferably, the air mass admitted into the engine 2 is reduced by closing the throttle housing 10 so that the pressure in the intake manifold 3 reaches a predetermined minimum pressure value (stage 36). In any case, the pressure in the intake manifold 3 should not be lower than said predetermined minimum pressure value, as this would cause a large increase in oil consumption.

There remains therefore a residual air flow which generates with an optimal advance a positive thermal torque C_comb, for example equal to +20 Nm.

In the absence of the resistive electrical torque C_el, the thermal torque C_comb would lead to a rapid and uncontrolled increase in speed, while the driver wishes to switch to the higher gear which requires the engine speed to decrease to a target speed value N_target calculated according to the speed of the vehicle V_{vehicle} and a gear ratio V₁₀₀₀, according to the following equation:

$${N}_{target} = \frac{{V}_{vehicle}}{{V}_{1000}} , \qquad ( Eq . 1 )$$

wherein the gear ratio (V₁₀₀₀) is expressed in km/h per 1000 rpm.

The total effective torque C equal to the sum of the thermal torque C_comb produced by the motor and the resistant torque C_el generated by the electric machine is slightly negative, in order to ensure the expected controlled decrease in speed until the target speed N_target is reached (stage 37) which makes it possible to engage the upper gear under the best conditions. Thus, the electronic control unit controls the electric machine 15 so as to generate a resisting torque C_el greater in absolute value than the thermal torque C_comb produced by the motor 2. For example, C_el is equal to −25 Nm and the total effective torque C is equal to −5 Nm.

The resistive electric torque C_el is representative of the work done by the electric machine to charge the battery 20. The chemical energy of the injected fuel for the production of the thermal torque C_comb is therefore transformed into electrical energy and stored in the battery 20. Thus, the fuel consumption can be decreased at other operating points, where the thermal torque of the engine 2 can be reduced by providing a positive electric torque generated by the electric machine 15 from the electric energy stored in the battery 20.

When the engine speed reaches the target speed N_target, the method continues with a stage 38 of engaging the upper gear R+1, wherein the electronic control unit 22 controls the operation of the engine 2 according to a conventional nominal setting. stage 38 corresponds to the end of the gear change and is accompanied by the engagement of the clutch by the driver.

FIG. 3 illustrates the evolution over time of different parameters of the motorization device 1 during an upward ratio change from R to R+1 according to the invention.

The proposed method makes it possible to reduce pollutant emissions and consumption compared to the conventional methods mentioned above, because by keeping the injection activated during the change of gear ratio the level of oxygen stored in the catalyst remains constant and far from the saturation threshold. It is therefore not necessary to lower it when accelerating again. By avoiding purging of catalyst 6, the proposed method avoids increases in NOx, particulates, and fuel consumption.

1.-9. (canceled)

10. A method for reducing the polluting emissions of a spark-ignition internal combustion engine associated with at least one electric machine capable of operating at least in a generator mode, capable of driving at least one driving wheel of a motor vehicle via a system for transmitting a driving torque of the vehicle,
wherein said method comprises:
a stage of changing a gear of a gearbox of said transmission system to a higher gear, said gear change stage comprising a prior stage of detecting a command to change said gear by the higher gear and a stage of engaging said higher gear corresponding to the end of the gear change;
a stage of engine adjustment carried out after the detection of said change command and comprising a fuel injection stage and a fuel ignition stage with a predetermined ignition advance that maximizes a thermal torque produced by the engine;
a stage of controlling said electric machine carried out concomitantly with the stage of adjusting the motor, said electric machine operating according to a generator mode which generates a resisting torque throughout the duration of the gear change.

11. The method according to claim 10, wherein the injected fuel amount corresponds to a unit richness target value.

12. The method according to claim 10, wherein the injected fuel amount corresponds to a predetermined target value of oxygen stored in a three-way catalyst mounted to the exhaust of the engine.

13. The method according to claim 10, wherein the stage of adjusting the engine comprises a stage of reducing the amount of air admitted into the engine to a minimum amount of air corresponding to a predetermined minimum pressure in an intake manifold of the engine.

14. The method according to claim 10, wherein the resistive torque is representative of the work performed by the electrical machine to charge a battery.

15. The method according to claim 10, wherein the total effective torque equal by definition to the sum of the thermal torque produced by the motor and the resistive torque generated by the electric machine is slightly negative.

16. The method according to claim 15, wherein the value of the total effective torque makes it possible to lower the speed of the engine to a target speed value (Ntarget) calculated as a function of the speed of the vehicle (Vvehicle) and of a gear ratio of the gearbox (V1000), according to the following equation:
$${N}_{target} = \frac{{V}_{vehicle}}{{V}_{1000}} , \qquad ( Eq . 1 )$$
wherein the gear ratio (V1000) is expressed in km/h per 1000 rpm.

17. The method according to claim 16, wherein the stage of engaging the upper gear is performed when the speed of the engine reaches the target speed value (Ntarget).

18. A motorization device of a motor vehicle comprising an electronic control unit, a spark-ignition internal combustion engine and at least one electric machine capable of operating at least in a generator mode, said motorization device being associated with a manual gearbox of a transmission system of said vehicle and implementing a method according to claim 10.
